(19) United States
(12) Patent Application Publication
(10) Pub. No.: US 2022/0285752 A1
(43) Pub. Date: Sep. 8, 2022

(54) BATTERY COOLING DEVICE WITH FIRE PROTECTION MATERIAL, BATTERY MODULE WITH FIRE PROTECTION MATERIAL, AND AIRCRAFT

(71) Applicant: Volocopter GmbH, Bruchsal (DE)

(72) Inventor: Nils ZIEGLER, Bretten (DE)

(73) Assignee: Volocopter GmbH, Bruchsal (DE)

(21) Appl. No.: 17/687,763

(22) Filed: Mar. 7, 2022

(30) Foreign Application Priority Data
Mar. 5, 2021 (DE) 102021105386.2

(51) Int. Cl. H01M 10/613; H01M 10/659; H01M 50/143

(52) U.S. Cl. CPC H01M 10/613; H01M 10/659; H01M 50/143; H01M 2220/20

(57) ABSTRACT

A battery cooling device for cooling at least one battery cell (1) of an electrically driven aircraft is provided, with a latent heat store (3). The battery cell is surrounded by a multilayer system having at least two layers (2,4) of fire protection material and a layer of the phase change material of the latent heat store, where an inner layer of the multilayer system, facing the battery cell, and an outer layer of the multilayer system, facing the surroundings, are formed of the fire protection material, and a middle layer, which is disposed between the inner and the outer layers, is formed of the phase change material of the latent heat store, and the fire protection material is of at least two-layer form, where a first layer of the fire protection material is mechanically stable in form and a second layer of the fire protection material comprises hydrated material.

### INCORPORATION BY REFERENCE

The following documents are incorporated herein by reference as if fully set forth: German Patent Application No. 10 2021 105 386.2, file Mar. 5, 2021.

### TECHNICAL FIELD

The invention relates to a battery cooling device for cooling at least one battery cell of an electrically driven aircraft. The invention further relates to a battery module and also to a vertical take-off and landing aircraft.

### BACKGROUND

Aircraft with electrical or part-electrical (hybrid) drive are typically supplied with power via batteries. These batteries require controlled thermal management to ensure that the cells do not reach critical temperatures during operation. In the event of excessive overheating or of mechanical damage to the battery, the separator inside the cell might otherwise be destroyed, with the consequences of an internal short circuit and a subsequent exothermic reaction, referred to as thermal runaway, of the battery cell.

For this purpose it is known practice from the prior art to cool battery cells using what are called phase change materials (PCMs), also known as latent heat stores. One such solution is described for example in document US 2015/0037647 A1. Unlike conventional materials, these phase change materials have a constant phase transition temperature. This means that the latent heat store can be supplied with or relieved of heat during the alteration in its physical state, without any change in its temperature. The absorption of heat instead results in a phase transition of the phase change material of the latent heat store, from solid to liquid/viscous, for example.

Disadvantages of the existing solutions known from the prior art are that the phase change materials typically are either designed for a temperature range which is suitable for cooling of the battery cells during operation or are designed only to protect the battery in significantly higher temperature ranges (typically several hundred degrees Celsius) for securement in the event of thermal runaway. Furthermore, the phase change materials lack the mechanical stability to protect adjacent battery cells from metal fragments or flames in the event of thermal runaway, or to prevent bursting of a battery cell.

The prior-art solutions are disadvantageous from the standpoint of safety as well, since in the event of thermal runaway of the battery cells the typical phase change materials begin to melt because of the high temperatures, then to evaporate and also to burn. The vapor pressure means that burning droplets of the molten PCM material can be distributed within the battery housing, an event of which should be avoided.

### SUMMARY

The problem addressed by the invention is therefore that of eliminating the disadvantages of battery cooling devices in the prior art and more particularly of increasing safety and fire protection.

This problem is solved by a battery cooling device having one or more of the features disclosed herein. Advantageous refinements of the battery cooling device are found in below and in the claims. The problem is also solved by a battery module and also by an having one or more of the features disclosed herein. Advantageous embodiments of the aircraft are also found below and in the claims. In order to avoid repetition, the claims are explicitly incorporated by reference into the description.

The battery cooling device of the invention for cooling at least one battery cell of an electrically driven aircraft comprises, conventionally, a latent heat store. The latent heat store is designed to absorb the heat given off by the battery in operation and to cool the battery by means of an isothermal change of state.

It is essential that the battery cell is surrounded by a multilayer system, said multilayer system comprising at least two layers of fire protection material and a layer of the phase change material of the latent heat store. In this arrangement an inner layer of the multilayer system, facing the battery cell, and an outer layer of the multilayer system, facing the surroundings, are formed of the fire protection material. A middle layer, which is disposed between the inner and the outer layers, is formed of the phase change material of the latent heat store. The fire protection material is in turn of at least two-layer form, where a first layer of the fire protection material is mechanically stable in form and a second layer of the fire protection material comprises hydrated material.

At minimum, therefore, the layer sequence of the multilayer system is composed of at least five layers as follows: adjacent the battery cell is the inner layer of the fire protection material, followed by a layer of the phase change material of the latent heat store. The multilayer system is closed off to the outside by at least one further layer of fire protection material. The inner and outer layers of fire protection material are in turn of two-layer form: a first layer of the inner layer of fire protection material is mechanically stable in form, and a second layer of the inner layer of fire protection material is formed with hydrated material. Equally a first layer of the outer layer of the fire protection material is mechanically stable in form, and a second layer of the outer layer of fire protection material is formed with hydrated material.

For the purposes of this description the terms “layer”, “wrap” or “ply” are used interchangeably.

In the event of thermal runaway of the battery cells, the high temperatures developed on thermal runaway are absorbed by the hydrated material of the second layer of the fire protection material. The material undergoes a phase change and is able accordingly to absorb at least part of the thermally released energy with no change in temperature. Furthermore, the first layer of the fire protection material, which is mechanically stable in form, prevents bursting of the battery cell. As a result, adjacent battery cells are protected not only against critical temperatures but also against mechanical damage due to metal fragments or the like. The adjacent battery cells therefore do not themselves enter a critical temperature range which would lead likewise to thermal runaway of the adjacent battery cells.

In one preferred embodiment of the invention the phase change material of the latent heat store is in macroencapsulated form in a carrier matrix. The advantage of this is that the material does not run.

The phase change material of the latent heat store is formed preferably as a cylindrical, slit sleeve which is disposed between two plies of the at least two-layer fire protection material on the cylindrical battery cell. In the operating state, the phase change material of the latent heat store absorbs heat depending on the latent heat and also on the heat capacity of the latent heat material. In this case there is a preferably isothermal phase transition in the phase change material. Discharging of the battery cells takes place typically during flight operation. The slit form of the sleeve of phase change material ensures that the sleeve can be fitted over the inner layer of the fire protection material. By wrapping with the outer layer of fire protection material, preferably self-adhesive fire protection material, the resulting compression enables effective thermal contact. Accordingly the heat of the battery cell can be conducted through the inner layer of fire protection material into the sleeve of phase change material.

In one preferred embodiment of the invention the first layer of the fire protection material is formed with fiber material, more particularly with glass fibers, ceramic fibers and/or basalt fibers. The advantage of this is that sufficient mechanical stability of the first layer of the fire protection material is achieved in a simple way.

The first layer of the fire protection material is preferably wrapped closely around the cell casing for mechanical protection, with no gap between the cell and the mechanically stable fibers. In this way it is possible to prevent bursting of the battery cell on thermal runaway.

The second layer of the fire protection material is formed preferably with hydrated materials, more particularly with at least one metal hydrate. Hydrated materials are mineral coolants which on heating beyond a certain limit temperature absorb large quantities of heat. The effect here is based on the evaporation of the water contained in the hydrated minerals. As a result of the evaporation it is possible to absorb a large quantity of heat through a substantially isothermal reaction.

The latent heat store and the self-adhesive, at least two-layer fire protection material are installed preferably in the following arrangement:

At least one inner wrap of the fire protection material is placed around the cell casing of the battery cell. The first layer of the fire protection material here consists of mechanically stable fibers and an adhesive strip which secures the fibers on the cell casing of the battery cell. The fibers prevent the battery cell from bursting laterally, i.e., on the cylindrical surface, in the event of overpressure during the thermal runaway of the battery cell (as occurs in the case, for example, of blocking of the CID valve). In order to obtain optimal stabilization, it is advantageous for the first, mechanically stable layer to bear directly against the casing of the battery cell.

The second layer of the fire protection material consists of a layer of hydrated minerals, such as water of crystallization, for example. This layer serves to absorb heat released during the thermal runaway, by evaporation of the water contained in the layer. During the phase transition of the hydrated minerals, the temperature of the material can be kept constant. An additional effect of the emerging water vapor is that it displaces the oxygen in the air, with a positive fire protection effect on adjacent components.

Sited following this inner wrap of the fire protection material is the latent heat store, preferably configured as a slit, cylindrical sleeve. The slitting enables compensation of tolerances that occur. During standard operation of the battery, the heat arising is conducted into the latent heat store by the fire protection material of the first wrap. In this case there is no phase transition in the fire protection material, since the design temperature required for such transition is high enough (>100° C.) to lead to phase transition only in the event of thermal runaway. In the latent heat store, conversely, the design melting temperature is preferably such that it occurs in standard operation when the cell is discharged, preferably in the range from 30° to 60° C., especially preferably around 43-49° C. To prevent the phase change material of the latent heat store beginning to run during the phase transition, it is embedded into a carrier material, in the form of macroencapsulation. So that the slit sleeve of the phase change material possesses effective thermal contact with the inner wrap of the fire protection material, a second, outer ply of fire protection material is wrapped around the outside of the sleeve. As a result of close wrapping, a compressive pressure is generated which results in effective thermal contact. A further advantage of this arrangement is that it in this way the latent heat store is cooled from two sides in the event of thermal runaway and is surrounded on two sides by a water vapor layer, which increases the fire protection.

Since, in spite of the bilateral cooling, it is possible during the thermal runaway for the latent heat store and its carrier matrix to melt and to begin to evaporate, the vapor of the evaporated composite material, more particularly of the evaporated phase change material, is preferably diverted in order to prevent an overpressure that could damage the fire protection material of the cell.

In another preferred embodiment of the invention the battery cell has a safety valve in the form of a venting valve. If the battery cell is overheated, leading to fire in the cell, the venting valve is able to open independently, and the hot, burning gas is able to escape from the battery cell in the event of thermal runaway of the battery. Should the venting valve become blocked during the thermal runaway event, the above-described mechanical protection in the form of the mechanically stable fibers of the fire protection material means that the cell does not rupture laterally, but that, instead, either the top or bottom side of the cell ruptures and the venting gases can consequently be dissipated in a controlled manner.

The invention is further achieved by a battery module having a battery cooling device and a plurality of battery cells. It is essential that the battery cooling device is formed as described above.

The battery cells are preferably formed as round cells. The advantage of this is that the battery module is mechanically stable.

The invention is likewise achieved by an aircraft having such a battery module. The aircraft is formed preferably as an electrically driven, vertical take-off and landing aircraft.

The invention is especially suitable for use in safety-critical sectors such as manned and unmanned air travel, more particularly in electrically driven, vertical take-off and landing aircraft of the applicant and also in battery modules of the applicant, such as, for example, in the applications “Battery cooling device and method for cooling a battery cell of an electrically driven aircraft” and “Method for cooling a battery and cooling system” with filing date of Mar. 5, 2020.

### BRIEF DESCRIPTION OF THE DRAWINGS

Further preferred features and embodiments are elucidated below with reference to working examples and the figures. These working examples and also any dimensions indicated are merely advantageous refinements of the invention and are therefore not limiting.

In the drawing:

FIG. 1 shows a first working example of a battery cooling device of the invention, in cross section.

### DETAILED DESCRIPTION

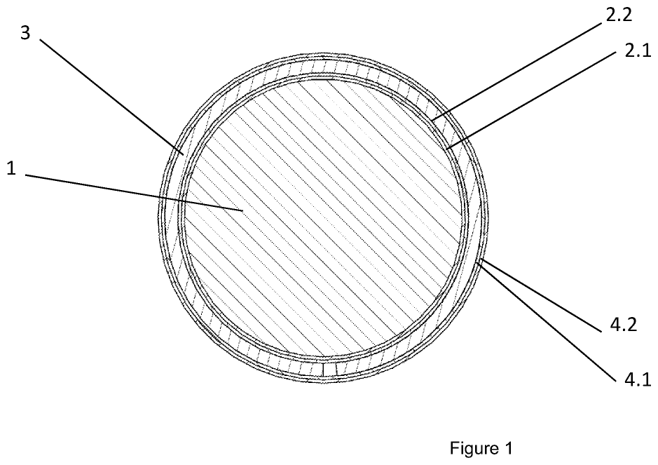

FIG. 1 shows a battery cell 1 in cross section. The battery cell 1 is a round cell and is cylindrical in form. The longitudinal extent of the battery cell 1 extends perpendicular to the drawing plane.

Sited around the cell casing of the battery cell 1 is the inner layer 2 of the fire protection material. The inner layer 2 of the fire protection material is presently of two-layer form.

The presently first layer 2.1 of the fire protection material is formed of mechanically stable fibers. The first layer 2.1 of the fire protection material 2 presently comprises glass fibers. The first layer 2.1 of the fire protection material is self-adhesive in form, through provision of an adhesive strip which bears against the cell casing of the battery cell and secures the inner layer of fire protection material to the cell casing of the battery cell. The mechanically stable fibers prevent the battery cell possibly bursting laterally, i.e., on the cylindrical surface, in the event of an overpressure during the thermal runaway of the battery cell (as occurs, for example, in the case of blocking of the CID valve).

The second layer 2.2 of the fire protection material consists of a layer of hydrated minerals, such as water of crystallization, for example. The second layer 2.2 of the fire protection material 2 is designed to absorb several hundred degrees Celsius, in the present instance around 600° C., substantially isothermally and to undergo a phase transition in the process. This layer 2.2 serves to absorb heat released during the thermal runaway, by evaporation of the water contained in the hydrated minerals.

As a result the temperature spikes in the event of thermal runaway of a battery cell 1 are buffered, and so the adjacent cells remain protected and do not pass into the critical temperature range at which they too would transition to thermal runaway.

Provided around the battery cell 1 and the inner layer 2 of the fire protection material, in the form of a sleeve, is the latent heat store 3. The latent heat store 3 is formed of phase change material in the form of a slit, cylindrical sleeve.

During standard operation of the battery, the heat arising is guided through the inner layer 2 of fire protection material into the latent heat store 3. In this case there is no phase transition by the second layer 2.2 of the fire protection material 2, since the temperature required for such transition (>100° C.) is not attained.

In the latent heat store 3, the melting temperature is presently designed such that it lies within the temperature range during standard operation (flight operation) of the battery cell. The temperature range during standard operation is presently around 43-49° C. This temperature range may be selected through selection of the phase change material of the latent heat store 3.

In order to prevent the phase change material of the latent heat store 3 beginning to run during the phase transition, it is embedded in macroencapsulated form in a carrier matrix.

Provided externally around the sleeve of phase change material 3 is the outer layer 4 of fire protection material. So that the slit sleeve 3 of the phase change material possesses effective thermal contact with the inner layer 2 of the fire protection material, the outer layer 4 of the fire protection material is wrapped around the outside of the sleeve of the phase change material 3. A close wrap produces a compressive pressure which leads to effective thermal contact.

In the present instance the outer layer 4 of fire protection material, analogously to the inner layer of fire protection material, is likewise of two-layer form. The first layer 4.1 of the fire protection material 4 is formed with fiber material and therefore mechanically stable. The first layer 4.1 of the fire protection material 4 presently comprises glass fibers.

The second layer 4.2 of the fire protection material 4 is formed with hydrated material for very high temperatures. The second layer 4.2 of the fire protection material 4 is presently formed of a metal hydrate, in the present instance water of crystallization. The outer layer 4 of the fire protection material is likewise of self-adhesive form, through provision on the first layer 4.1 of an adhesive strip which bears against the slit sleeve 3. As described above, a close wrap generates a compressive pressure which leads to effective thermal contact between the various layers.

An advantage of arranging the latent heat store of phase change material between two layers of fire protection material with hydrated material is that the latent heat store in the event of thermal runaway is cooled from two sides and is surrounded on two sides by a water vapor layer, which increases fire protection.

1. A battery cooling device for cooling at least one battery cell (1) of an electrically driven aircraft, the battery cooling device comprising:
a latent heat store (3),
a multilayer system surrounding the at least one battery cell, said multilayer system comprising at least two layers (2, 4) of fire protection material and a layer of a phase change material that forms the latent heat store (3),
the at least two layers of the multilayer system include an inner layer (2) facing the at least one battery cell (1), and an outer layer (4) facing surroundings, the inner and outer layers are formed of the fire protection material, and a middle layer (3), which is disposed between the inner layer (2) and the outer (4) layer, is formed by the layer of the phase change material of the latent heat store (3), and
the fire protection material (3) comprises at least two layers, in which a first layer (2.1, 4.1) of the fire protection material is mechanically stable in form and a second layer of the fire protection material (2.2, 4.2) comprises hydrated material.

2. The battery cooling device as claimed in claim 1, wherein the first layer of the fire protection material (2.1) of the inner layer (2) is disposed directly on the at least one battery cell (1).

3. The battery cooling device as claimed in claim 1, wherein the phase change material of the latent heat store (3) is macroencapsulated in a carrier matrix.

4. The battery cooling apparatus as claimed in claim 1, wherein the phase change material of the latent heat store (3) is formed as a slit sleeve around the inner layer (2) of fire protection material.

5. The battery cooling apparatus as claimed in claim 1, wherein the phase change material of the latent heat store (3) is configured for a temperature range for an evolution of heat by the at least one battery cell (1) in an operating state.

6. The battery cooling device of claim 5, wherein the temperature range is from 20° C. to 150° C.

7. The battery cooling device as claimed in claim 1, wherein the first layer (2.1, 4.1) of the fire protection material (2, 4) is formed with fiber material.

8. The battery cooling device as claimed in claim 7, wherein the fiber material comprises at least one of glass fibers, ceramic fibers, or aramid fibers

9. The battery cooling device as claimed in claim 1, wherein the second layer of the fire protection material (2.2, 4.2) is formed with hydrated minerals.

10. The battery cooling device as claimed in claim 9, wherein the hydrated minerals comprise at least one metal hydrate.

11. The battery cooling device as claimed in claim 1, wherein the second layer of the fire protection material (2.2, 4.2) is configured for a temperature range for an evolution of heat by the battery cell on thermal runaway of the battery cell.

12. The battery cooling device as claimed in claim 11, wherein the temperature range is from 100° to 800°.

13. The battery cooling device as claimed in claim 1, wherein at least one of the inner (2) or the outer (4) layers of fire protection material are self-adhesive.

14. The battery cooling device as claimed in claim 13, wherein the first, mechanically stable layer (2.1, 4.1) of the fire protection material is self-adhesive.

15. The battery cooling device as claimed in claim 1, wherein the outer layer (4) of fire protection material completely envelops the phase change material of the latent heat store (3).

16. The battery cooling device as claimed in claim 1, wherein the inner (2) and the outer (4) layers of the fire protection material (2.2) are formed as a sleeve, and the sleeve of the outer layer of the fire protection material (4.2) overlaps the phase change material of the latent heat store (3) on both sides at the openings in the sleeve and is formed sealingly with the inner layer (2.2) of the fire protection material.

17. A battery module comprising the battery cooling device of claim 1 and a plurality of battery cells (1).

18. An aircraft comprising a battery module as claimed in claim 17.

19. The aircraft as claimed in claim 18, wherein the aircraft comprises an electrically driven, vertical take-off and landing aircraft.
